(19) United States
(12) Patent Application Publication
(10) Pub. No.: US 2021/0161750 A1
(43) Pub. Date: Jun. 3, 2021

(54) LEG BRACE, LEG BRACE UNIT, AND LOWER-LIMB SYSTEM

(71) Applicant: TOYOTA JIDOSHA KABUSHIKI KAISHA, Toyota-shi (JP)

(72) Inventors: Eisuke AOKI, Toyota-shi (JP); Tadashi ODASHIMA, Toyota-shi (JP); Tomio IKEDA, Toyota-shi (JP)

(73) Assignee: TOYOTA JIDOSHA KABUSHIKI KAISHA, Toyota-shi (JP)

(21) Appl. No.: 17/071,755

(22) Filed: Oct. 15, 2020

(30) Foreign Application Priority Data
Nov. 28, 2019 (JP) 2019-215429

(51) Int. Cl. A61H 3/00

(52) U.S. Cl. CPC A61H 3/00; A61H 2003/007; A61H 2205/106; A61H 2201/1642; A61H 2201/0165; A61H 2201/12; A61H 2205/108

(57) ABSTRACT

A knee joint weight-bearing apparatus, which is used as a leg brace, includes an inner thigh link, an inner lower-leg link, inner extension force generation means for generating an inner extension force between the inner thigh link and the inner lower-leg link in a direction in which a knee joint of a leg extends, an outer thigh link, an outer lower-leg link, and outer extension force generation means for generating an outer extension force between the outer thigh link and the outer lower-leg link in a direction in which the knee joint of the leg extends. The inner extension force is stronger than or weaker than the outer extension force.

### CROSS REFERENCE TO RELATED APPLICATIONS

This application is based upon and claims the benefit of priority from Japanese patent application No. 2019-215429, filed on Nov. 28, 2019, the disclosure of which is incorporated herein in its entirety by reference.

### BACKGROUND

The present disclosure relates to a leg brace, a leg brace unit, and a lower-limb system.

Knee osteoarthritis in which due to deterioration of cartilage or wear thereof in a knee joint, a pain is caused in the knee joint during walking has been know.

In the early stage of knee osteoarthritis, walking on level ground does not cause a problem, but the patient may feel a pain in his/her knee when he/she goes up and down stairs. Alternatively, the patient does not feel a pain in his/her knee during walking, but he/she cannot sit down in the Japanese “seiza” style (i.e., cannot sit on his/her heels) because of a pain in the knee joint.

As the knee osteoarthritis progresses, both legs become O-shaped bowlegs or X-shaped bowlegs. As a result, the burden on the knee joint increases due to the wear of the cartilage and hence the knee joint becomes arthritic. Further, because of the arthritis, mere bending and stretching of the knee joint become painful. Therefore, the patient has a difficulty in not only going up and down stairs, but also walking on level ground.

Further, as the knee osteoarthritis progresses even further, the cartilage disappears (i.e., is completely worn out) and the thighbone and the shinbone directly rub against each other, thus causing a severe pain.

As a known method for surgically treating knee osteoarthritis, there is total knee replacement in which a knee joint is replaced with an artificial material made of metal or resin. As a known method for non-surgically treating knee osteoarthritis, an anti-inflammatory analgesic may be administered.

Published Japanese Translation of PCT International Publication for Patent Application, No. 2018-518318 discloses an artificial knee including a thigh link fixed to a thigh of a user, a shin link fixed to a shin thereof, and a passive compressive force generator that resists bending of the shin link with respect to the thigh link. The passive compressive force generator is, for example, an air spring or a compression coil spring.

### SUMMARY

One of the objects of the present disclosure is to provide a technique for alleviating a pain in a knee joint of a patient suffering from knee osteoarthritis.

A first exemplary aspect is a leg brace configured to be attached to a leg of a user, including: an inner thigh link configured to be attached to an inner side of a thigh of the leg; an inner lower-leg link rotatably connected to the inner thigh link, and configured to be attached to an inner side of a lower leg of the leg; inner extension force generation means for generating an inner extension force between the inner thigh link and the inner lower-leg link in a direction in which a knee joint of the leg extends; an outer thigh link configured to be attached to an outer side of the thigh of the leg; an outer lower-leg link rotatably connected to the outer thigh link, and configured to be attached to an outer side of the lower leg of the leg; and outer extension force generation means for generating an outer extension force between the outer thigh link and the outer lower-leg link in a direction in which the knee joint of the leg extends, in which the inner extension force is stronger than or weaker than the outer extension force. According to the above-described configuration, it is possible, when the leg to which the leg brace is attached becomes a stance state, to guide the center of gravity of the user to the weaker one of the inner extension force side and the outer extension force side, and thereby to alleviate a pain caused by knee osteoarthritis.

The inner extension force may be stronger than the outer extension force. According to the above-described configuration, it is possible, when the leg to which the leg brace is attached becomes the stance state, to guide the center of gravity of the user toward the outer side, and thereby to alleviate a pain caused by knee osteoarthritis when the leg is an O-shaped bowleg.

The inner extension force may be weaker than the outer extension force. According to the above-described configuration, it is possible, when the leg to which the leg brace is attached becomes the stance state, to guide the center of gravity of the user toward the inner side, and thereby to alleviate a pain caused by knee osteoarthritis when the leg is an X-shaped bowleg.

The inner extension force generation means and the outer extension force generation means may include a spring or a damper.

The inner extension force generation means and the outer extension force generation means may include a spring configured so that its spring constant is adjustable.

The inner extension force generation means and the outer extension force generation means may include a damper configured so that its damping coefficient is adjustable.

A second exemplary aspect is a leg brace configured to be attached to a leg of a user, including: a thigh link configured to be attached to a thigh of the leg; a lower-leg link rotatably connected to the thigh link, and configured to be attached to a lower leg of the leg; and extension force generation means for generating an extension force between the thigh link and the lower-leg link in a direction in which a knee joint of the leg extends, in which the thigh link and the lower-leg link form a link unit, and the link unit is disposed only on one of an inner side and an outer side of the leg. According to the above-described configuration, it is possible, when the leg on which the leg brace is attached becomes a stance state, to guide the center of gravity of the user toward the side opposite to the side on which the link unit is disposed, and thereby to alleviate a pain caused by knee osteoarthritis.

The link unit may be disposed on an inner side of the leg. According to the above-described configuration, it is possible, when the leg to which the leg brace is attached becomes the stance state, to guide the center of gravity of the user toward the outer side, and thereby to alleviate a pain caused by knee osteoarthritis when the leg is an O-shaped bowleg.

The link unit may be disposed on an outer side of the leg. According to the above-described configuration, it is possible, when the leg to which the leg brace is attached becomes the stance state, to guide the center of gravity of the user toward the inner side, and thereby to alleviate a pain caused by knee osteoarthritis when the leg is an X-shaped bowleg.

A third exemplary aspect is a leg brace unit including a pair of leg braces each of which is attached to a respective one of legs of a user, in which each of the leg braces includes: a thigh link configured to be attached to a thigh of a corresponding leg; a lower-leg link rotatably connected to the thigh link, and configured to be attached to a lower leg of the corresponding leg; and extension force generation means for generating an extension force between the thigh link and the lower-leg link in a direction in which a knee joint of the leg extends, and an extension force of one of the leg braces is stronger than or weaker than that of the other leg brace. According to the above-described configuration, it is possible to guide the center of gravity of the user to the side on which the extension force is weaker, and thereby to alleviate a pain caused by knee osteoarthritis.

A fourth exemplary aspect is a lower-limb system including: a brace main body configured to be attached to a lower limb of a user; a load removal detection unit configured to detect that a load exerted on the lower limb is removed; force-applying means capable of applying a force to the brace main body in a direction in which the brace main body recedes from a ground surface; and a control unit configured to control the force-applying means so that when the load exerted on the lower limb is removed, the force-applying means applies the force to the brace main body in the direction in which the brace main body recedes from the ground surface. According to the above-described configuration, it is possible to guide the center of gravity of the user toward the lower limb opposite to the lower limb to which the lower-limb brace is attached, and thereby to alleviate a pain in the lower limb opposite to the lower limb to which the lower-limb brace is attached caused by knee osteoarthritis of that lower limb when that leg is an O-shaped bowleg.

According to the present disclosure, it is possible to alleviate a pain in a knee joint of a patient suffering from knee osteoarthritis.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective view of a knee joint weight-bearing apparatus (First Embodiment);

FIG. 2 is a schematic side view of a knee joint weight-bearing apparatus when the knee joint is stretched (First Embodiment);

FIG. 3 is a schematic side view of the knee joint weight-bearing apparatus when the knee joint is bent (First Embodiment);

FIG. 4 shows a state in which a user sits on a chair while wearing the knee joint weight-bearing apparatus (First Embodiment);

FIG. 5 is a schematic front view of a leg brace (Second Embodiment);

FIG. 6 is a side view of force-applying means of the leg brace (Second Embodiment);

FIG. 7 is a schematic front view showing a leg brace attached to a diseased leg in the case where the diseased leg is an O-shaped bowleg (Third Embodiment);

FIG. 8 is a schematic front view showing a leg brace attached to a diseased leg in the case where the diseased leg is an X-shaped bowleg (Fourth Embodiment);

FIG. 9 is a schematic front view showing leg braces each of which is attached a respective one of both legs in the case where the legs are O-shaped bowlegs (Fifth Embodiment); and

FIG. 10 is a schematic front view showing a lower-limb brace attached to a diseased leg in the case where the diseased leg is an O-shaped bowleg (Sixth Embodiment).

### DESCRIPTION OF EMBODIMENTS

### First Embodiment

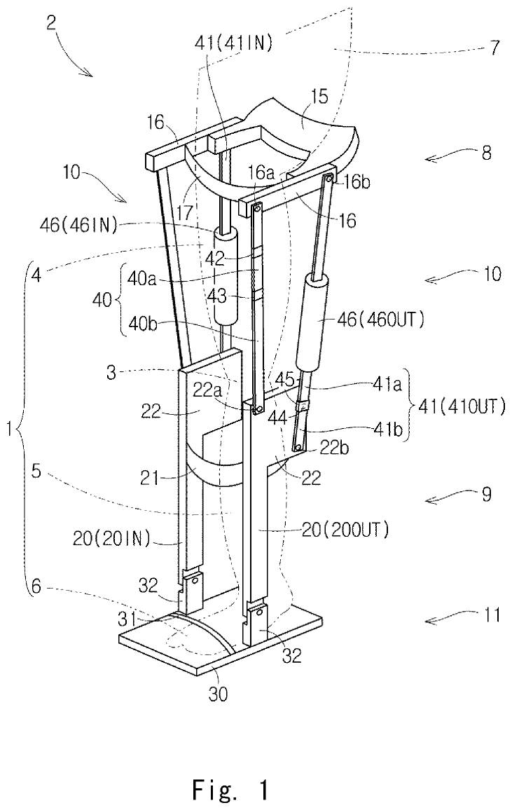

A first embodiment according to the present disclosure will be described hereinafter with reference to FIGS. 1 to 4.

FIG. 1 shows a knee joint weight-bearing apparatus 2 which is attached to a leg 1 of a user when it is used. The knee joint weight-bearing apparatus 2 is typically used while being attached to one of the two legs 1 of the user in which the user suffers from knee osteoarthritis. However, one knee joint weight-bearing apparatus 2 may be attached to each of both legs 1.

The knee joint weight-bearing apparatus 2 is an apparatus that, by being attached to the leg 1 of the user, relieves a part or the whole of the load (e.g., the weight) exerted on the knee joint 3 of the leg 1. In this embodiment, by being attached to the leg 1 of the user, the knee joint weight-bearing apparatus 2 relieves a part of the load exerted on the knee joint 3 of the leg 1.

As being well known, the leg 1 includes a thigh 4, a lower leg 5, and a foot 6. A buttock 7 is positioned above the leg 1. The knee joint 3 is a joint that connects the thigh 4 with the lower leg 5.

The knee joint weight-bearing apparatus 2 includes a buttock attaching part 8, a lower-leg attaching part 9, and two thigh connection units 10. The knee joint weight-bearing apparatus 2 further includes a foot attaching part 11.

In the following description, a front/rear direction and a left/right direction are defined based on the orientation of the body of the user. A forward direction may be defined as the normal walking direction of the user. The left/right direction may be defined as the longitudinal direction of a line segment that horizontally connects the right and the left arms.

### Buttock Attaching Part 8

The buttock attaching part 8 is a part that is attached to the buttock 7 of the user and supports the buttock 7 of the user. The buttock attaching part 8 includes a buttock facing part 15, two buttock frames 16, and a buttock fixing band 17.

The buttock facing part 15 is a part that is substantially opposed to (i.e., faces) the hipbone of the buttock 7 of the user when the user is in a stance state or a sitting position. In this embodiment, the buttock facing part 15 is positioned rearward of and below the hipbone of the user's buttock 7. The buttock facing part 15 may has an open-cell structure such as urethane foam, or a closed-cell structure such as polyethylene foam for the purpose of dispersing a contact pressure exerted to the user.

The two buttock frames 16 are arranged so as to sandwich the user's thigh 4 in the left/right direction of the user. Each of the buttock frames 16 is fixed to the buttock facing part 15 by, for example, a screw and extends forward from the buttock facing part 15. Each of the buttock frames 16 horizontally extends substantially in a straight line along the front/rear direction of the user when the user is in the stance state. It can be expressed that the two buttock frames 16 are connected to each other by the buttock facing part 15. Each of the buttock frames 16 includes a front thigh link upper end connection part 16a and a rear thigh link upper end connection part 16b. The front thigh link upper end connection part 16a is positioned forward of the rear thigh link upper end connection part 16b.

The buttock fixing band 17 is a band for fixing the buttock attaching part 8 to the base of the user's thigh 4, and is disposed between the two buttock frames 16. The buttocks fixing band 17 is disposed so as to connect two buttocks frames 16 with each other. The buttock fixing band 17 is disposed on the opposite side to the buttock facing part 15 across the user's thigh 4. By the above-described configuration, the user can appropriately attach the buttock attaching part 8 to his/her buttock 7 by adjusting the band length of the buttock fixing band 17 according to the thickness of the base of the user's thigh 4.

### Lower-leg Attaching Part 9

The lower-leg attaching part 9 is a part that is attached to the lower leg 5 of the user. The lower-leg attaching part 9 includes two lower-leg facing parts 20 and a lower-leg fixing band 21.

The two lower-leg facing parts 20 are arranged so as to sandwich the user's lower leg 5 in the left/right direction. Each of the lower-leg facing parts 20 vertically extends along the lower leg 5. A thigh link connection part 22, to which a respective one of the thigh connection units 10 is connected, is formed at the upper end of each of the lower-leg facing parts 20.

The thigh link connection part 22 includes a front thigh link lower end connection part 22a and a rear thigh link lower end connection part 22b. The front thigh link lower end connection part 22a is positioned forward of and above the rear thigh link lower end connection part 22b. The front thigh link lower end connection part 22a is positioned at roughly the same height as the user's knee joint 3 when the user is in the standing state. The rear thigh link lower end connection part 22b is positioned below the user's knee joint 3 when the user is in the standing state. Specifically, when the height of the user is represented by HT, the rear thigh link lower end connection part 22b is disposed at a position that is lower than the user's knee joint 3 by a length HT*0.1 to HT*0.15 when the user is in the standing state.

The lower end of each of the lower-leg facing parts 20 is rotatably connected to the foot attaching part 11.

### Foot Attaching Part 11

The foot attaching part 11 is a part that is fixed to the foot 6 of the user. As shown in FIG. 1, like a sandal, the foot attaching part 11 may include a sole part 30 that is opposed to (i.e., faces) the sole of the foot 6, a foot fixing band 31 that is opposed to (i.e., faces) the instep of the foot 6, and two foot projecting parts 32. The user can appropriately attach the foot attaching part 11 to his/her foot 6 by putting the foot 6 between the sole part 30 and the foot fixing band 31 and adjusting the band length of the foot fixing band 31. The two foot projecting parts 32 project upward from the sole part 30 so as to sandwich the foot 6 in the left/right direction. The lower end of each of the lower-leg facing parts 20 of the lower-leg attaching part 9 is rotatably connected to the upper end of a respective one of the leg projecting parts 32 of the leg attaching part 11. Note that the foot attaching part 11 may be formed like a boot, a sneaker, a leather shoe, or a slip-on, instead of being formed like a sandal. For example, when the foot attaching part 11 is formed like a boot, the lower end of each of the lower-leg facing parts 20 of the lower-leg attaching part 9 is rotatably connected to one (or some) of the components constituting the boot.

### Thigh Connecting Unit 10

The two thigh connection units 10 are arranged so as to sandwich the user's thigh 4 in the left/right direction. Each of the thigh connection units 10 extends in the vertical direction when the user is in the standing state. Each of the thigh connection units 10 connects the buttock attaching part 8 with the lower-leg attaching part 9. Details of the thigh connection units 10 are described hereinafter.

Each of the thigh connection units 10 includes a front thigh link 40 and a rear thigh link 41. The front thigh link 40 connects the buttock attaching part 8 with the lower-leg attaching part 9. The rear thigh link 41 also connects the buttock attaching part 8 with the lower-leg attaching part 9. The rear thigh link 41 is disposed rearward of the front thigh link 40. The longitudinal directions of the front and rear thigh links 40 and 41 are roughly parallel to each other. The front and rear thigh links 40 and 41 extend roughly vertically when the user is in the standing state.

The upper end of the front thigh link 40 of each of the thigh connection units 10 is rotatably connected to the front thigh link upper end connection part 16a of a respective one of the buttock frames 16 of the buttock attaching part 8. The lower end of the front thigh link 40 of each of the thigh connection units 10 is rotatably connected to the front thigh link lower end connection part 22a of the thigh link connection part 22 of a respective one of the lower leg facing parts 20 of the lower-leg attaching part 9.

The upper end of the rear thigh link 41 of each of the thigh connection units 10 is rotatably connected to the rear thigh link upper end connection part 16b of a respective one of the buttock frames 16 of the buttock attaching part 8. The lower end of the rear thigh link 41 of each of the thigh connection units 10 is rotatably connected to the rear thigh link lower end connection part 22b of the thigh link connection part 22 of a respective one of the lower leg facing parts 20 of the lower-leg attaching part 9.

Therefore, each of the buttock frames 16 of the buttock attaching part 8, the front and rear thigh links 40 and 41 of a respective one of the thigh connection units 10, and the thigh link connection part 22 constitute the so-called four-bar linkage.

In this embodiment, the front thigh link 40 is a string made of a flexible material, typically made of a polyamide synthetic resin such as nylon. The front thigh link 40 is formed by connecting the front thigh link upper part 40a with the front thigh link lower part 40b. Further, the front thigh link 40 includes a length adjusting mechanism 42 and a detaching mechanism 43 (a front upper/lower connection part). The length adjusting mechanism 42 is a mechanism for adjusting the link length of the front thigh link 40, i.e., the distance between the front thigh link upper end connection part 16a and the front thigh link lower end connection part 22a, and is typically formed by a belt feed. In this embodiment, the length adjusting mechanism 42 adjusts the link length of the front thigh link upper part 40a. However, instead of adjusting the link length of the front thigh link upper part 40a, the link length of the front thigh link lower part 40b may be adjusted. The detaching mechanism 43 is a mechanism for temporarily detaching the front thigh link 40, and is typically a buckle. The detaching mechanism 43 detachably connects the front thigh link upper part 40a with the front thigh link lower part 40b.

In this embodiment, the front thigh link 40 is made of a flexible material. However, the front thigh link 40 may be made of a non-flexible material. For example, the front thigh link 40 is formed of a beam made of metal or wood. Further, specific examples of the flexible material are not limited to the above-shown synthetic resins and may include metals. In such cases, the front thigh link 40 may be a metal wire.

The rear thigh link 41 is composed of a rear thigh link upper part 41a and a rear thigh link lower part 41b. The rear thigh link upper part 41a and the rear thigh link lower part 41b are rotatably connected to each other at a rear thigh connection part 44. The rear thigh connection part 44 is provided with a switching snap 45 (a rear upper/lower connection part) for switching between a state in which the rear thigh link upper part 41a is relatively rotatable with respect to the rear thigh link lower part 41b and a state in which the rear thigh link upper part 41a is not rotatable with respect to the rear thigh link lower part 41b. The switching snap 45 is typically a tubular member provided in the rear thigh link lower part 41b in such a manner that the tubular member is slidable along the rear thigh link lower part 41b in its longitudinal direction. In this case, when the switching snap 45 is slid upward and thereby covers both the rear thigh link upper part 41a and the rear thigh link lower part 41b at the same time, the rear thigh link 41 becomes the aforementioned non-rotatable state. Further, when the switching snap 45 is slid downward and hence does not cover the rear thigh link upper part 41a, the rear thigh link 41 becomes the aforementioned rotatable state. The configuration of the switching snap 45 is not limited to the above-described configuration. That is, other known configurations may be adopted for the switching snap 45. The rear thigh connection part 44 and the switching snap 45 are disposed near the knee joint 3.

A gas spring 46 (resistive-force generation means) is provided in the rear thigh link upper part 41a. The gas spring 46 is a spring using a reaction force of a compressed gas, and obtains the reaction force by filling a sealed cylinder with a nitrogen gas, which is used as the compressed gas, and compressing the gas by a piston. The gas spring 46 is configured so that the rear thigh link upper part 41a can extend and contract in the longitudinal direction thereof. The gas spring 46 generates a roughly constant repulsive force irrespective of the link length of the rear thigh link upper part 41a in the direction in which the link length of the rear thigh link upper part 41a increases.

Regarding the buttock attaching part 8, the buttock attaching part 8 is considered to be a problem of a beam in which the buttock attaching part 8 is simply supported by the front and rear thigh link upper end connection parts 16a and 16b, and distributed loads (e.g., distributed weights) are exerted downward on the buttock facing part 15. In this case, the buttock facing part 15 is configured so that a concentrated load equivalent to downward distributed loads exerted on the buttock facing part 15 is exerted on a part of the buttock facing part 15 located rearward of the rear thigh link upper end connection part 16b. Therefore, when the user applies a load (e.g., his/her weight) to the buttock facing part 15, a tensile force is generated in the front thigh link 40 and a compressive force acts on the rear thigh link 41.

Further, the repulsive force generated by the gas spring 46 is the resistive force itself against the above-described compressive force.

The above-described knee joint weight-bearing apparatus 2 is particularly suitable for knee osteoarthritis.

The knee osteoarthritis causes a symptom in which cartilage in a knee joint deteriorates or is worn away, causing a pain in the knee joint during walking.

In the early stage of knee osteoarthritis, walking on level ground surface does not cause a problem, but the patient may feel a pain in his/her knee when he/she goes up and down stairs. Alternatively, the patient does not feel a pain in his/her knee during walking, but he/she cannot sit down in the Japanese “seiza” style (i.e., cannot sit on his/her heels) because of a pain in the knee joint.

As the knee osteoarthritis progresses, both legs become O-shaped bowlegs or X-shaped bowlegs. As a result, the burden on the knee joint increases due to the wear of the cartilage and hence the knee joint becomes arthritic. Further, because of the arthritis, mere bending and stretching of the knee joint become painful. Therefore, the patient has a difficulty in not only going up and down stairs, but also walking on level ground surface.

Further, as the knee osteoarthritis progresses even further, the cartilage disappears (i.e., is completely worn out) and the thighbone and the shinbone directly rub against each other, thus causing a severe pain.

For a patient with knee osteoarthritis, the most direct cause of a pain in the knee joint is that the knee joint supports the weight of the upper body of the patient. Therefore, if a part or the whole of the load (e.g., the weight) exerted on the knee joint can be relieved, the pain in the knee joint can be alleviated.

Therefore, the knee joint weight-bearing apparatus 2 functions as an apparatus for relieving a part or the whole of the load exerted on the knee joint 3. In this embodiment, the knee joint weight-bearing apparatus 2 functions as an apparatus for relieving a part of the load exerted on the knee joint 3.

Specifically, once the knee joint weight-bearing apparatus 2 is attached to the leg 1, the user feels, when he/she walks, as if he/she is walking while sitting on a chair at all times. Note that the buttock attaching part 8 of the knee joint weight-bearing apparatus 2 functions as a sitting surface of the chair, and both of the thigh connection units 10 and the lower-leg attaching part 9 function as legs of the chair.

Specific operations of the knee joint weight-bearing apparatus 2 are described hereinafter.

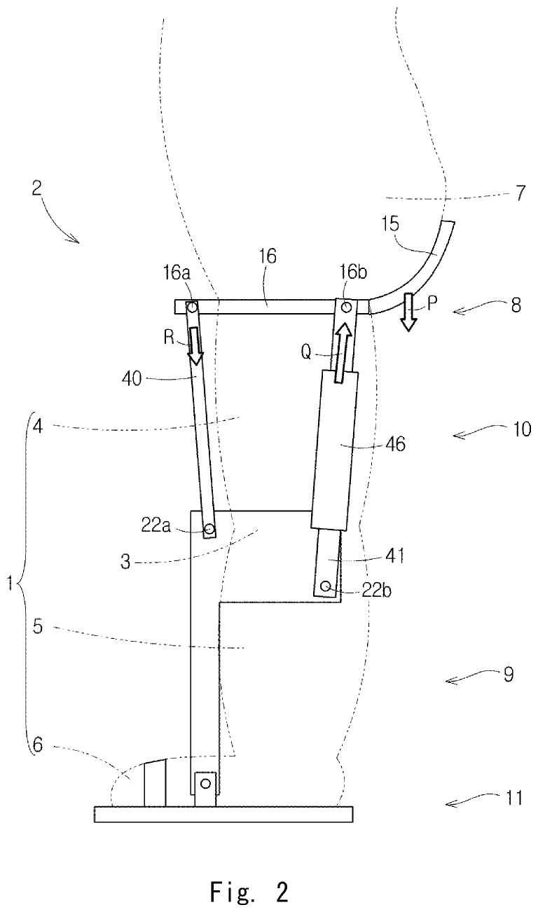

That is, as shown in FIG. 2, when a user applies a load P (e.g., his/her weight) to the buttock facing part 15, this load is received by the two thigh connection units 10 and the lower-leg attaching part 9. In this state, a compressive force acts on the rear thigh link 41 of each of the thigh connection units 10. Meanwhile, a tensile force R acts on the front thigh link 40 of each of the thigh connection units 10. The following relation holds: the front thigh link upper end connection part 16a acts as a fulcrum; the buttock facing part 15 becomes a point of force; and the rear thigh link upper end connection part 16b becomes a point of action. In this state, the gas spring 46 generates a resistive force Q against the compressive force acting on the rear thigh link 41. A part of the load exerted on the user's knee joint 3 is relieved by this resistive force Q.

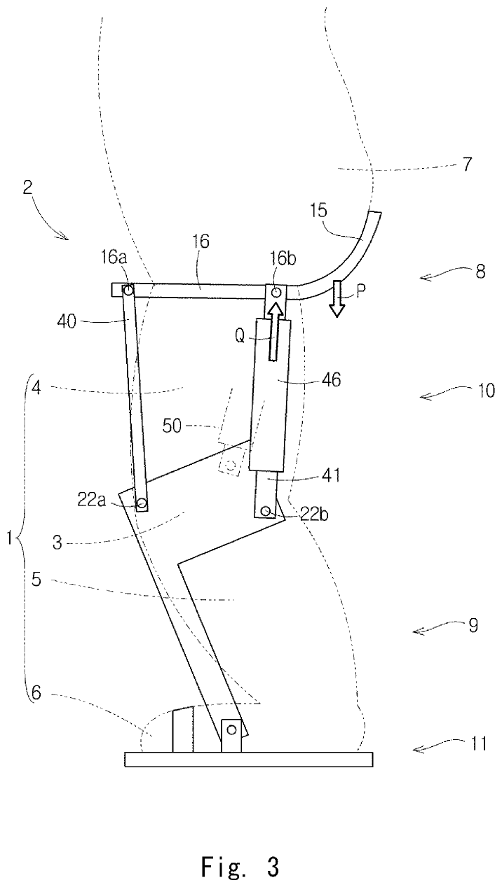

Next, as shown in FIG. 3, when the knee joint 3 of the leg 1 is bent, the lower leg 5 is inclined forward. Therefore, the lower-leg attaching part 9 is also inclined forward in a similar manner. In this state, since the gas spring 46 becomes moderately short, the posture of the buttock facing part 15 does not lean forward. Therefore, the user can easily continue applying the load to the buttock attaching part 8 without feeling that anything is wrong. That is, the function of the knee joint weight-bearing apparatus 2 for relieving a part of the load exerted on the user's knee joint 3 is continuously performed without causing any problem.

Note that as shown in FIG. 2, the rear thigh link lower end connection part 22b is disposed below the knee joint 3 and away from the knee joint 3 when the user is in the stance state. Therefore, as compared to the case where the rear thigh link lower end connection part 22b is disposed at the same height as the knee joint 3 when the user is in the stance state as shown by phantom lines 50 in FIG. 3, the inclination of the rear thigh link 41 that is caused when the knee joint 3 is bent is reduced. Therefore, the longitudinal direction of the rear thigh link 41 roughly coincides with the direction in which the user applies the load to the buttock attaching part 8, thus providing an advantage that the user can easily apply the load to the buttock attaching part 8 along the longitudinal direction of the rear thigh link 41. In other words, as compared to the case where the rear thigh link lower end connection part 22b is disposed at the same height as the knee joint 3 when the user is in the stance state as shown by the phantom lines 50 in FIG. 3, when the knee joint 3 is bent, the user can easily compress the gas spring 46 and hence can stabilize the posture of the buttock attaching part 8 without inclining it forward.

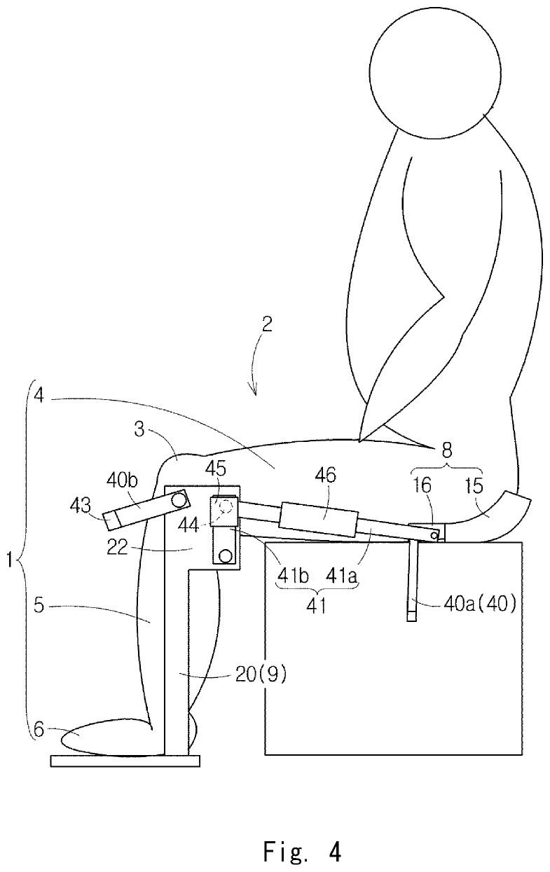

FIG. 4 shows a sitting position of a user. The sitting position means a position (i.e., a posture) in which the user sits on a chair or the like. As shown in FIG. 4, when a user with the knee joint weight-bearing apparatus 2 attached to his/her leg change his/her position from the stance state to the sitting position, he/she brings the rear thigh link upper part 41a and the rear thigh link lower part 41b of each of the thigh connection units 10 into a relatively rotatable state by using the switching snap 45. In addition, he/she may detach the front thigh link upper part 40a from the front thigh link lower part 40b by using the detaching mechanism 43. In this way, the front thigh link 40 can be bent at the rear thigh connection part 44. To begin with, the rear thigh connection part 44 is disposed near the knee joint 3, so that the knee joint weight-bearing apparatus 2 does not hamper the bending motion of the knee joint 3 by the user.

It should be noted that in the above-described first embodiment, the knee joint weight-bearing apparatus 2 is a specific example of the leg brace attached to the leg 1 of the user.

As shown in FIG. 1, the knee joint weight-bearing apparatus 2 includes an inner thigh link 41IN attached on the inner side of the thigh 4 of the leg 1. The inner thigh link 41IN corresponds to the rear thigh link 41 of the thigh connection unit 10 disposed on the inner side of the thigh 4 of the leg 1.

The knee joint weight-bearing apparatus 2 includes an inner lower-leg link 20IN that is rotatably connected to the inner thigh link 41IN, and attached on the inner side of the lower leg 5 of the leg 1. The inner lower-leg link 20IN corresponds to the lower leg facing part 20 disposed on the inner side of the lower leg 5 of the leg 1.

The knee joint weight-bearing apparatus 2 includes an inner gas spring 46IN that generates an inner extension force between the inner thigh link 41IN and the inner lower-leg link 20IN in a direction in which the knee joint 3 of the leg 1 extends. The inner gas spring 46IN is a specific example of the inner extension force generation means. The inner gas spring 46IN corresponds to the gas spring 46 disposed in the rear thigh link 41 of the thigh connection unit 10 disposed on the inner side of the thigh 4 of the leg 1. As shown in FIGS. 2 and 3, the inner extension force corresponds to the resistive force Q generated by the gas spring 46 disposed in the rear thigh link 41 of the thigh connection unit 10 disposed on the inner side of the thigh 4 of the leg 1.

Referring to FIG. 1 again, the knee joint weight-bearing apparatus 2 includes an outer thigh link 41OUT attached on the outer side of the thigh 4 of the leg 1. The outer thigh link 41OUT corresponds to the rear thigh link 41 of the thigh connection unit 10 disposed on the outer side of the thigh 4 of the leg 1.

The knee joint weight-bearing apparatus 2 includes an outer lower-leg link 20OUT that is rotatably connected to the outer thigh link 41OUT, and attached on the outer side of the lower leg 5 of the leg 1. The outer lower-leg link 20OUT corresponds to the lower leg facing part 20 disposed on the outer side of the lower leg 5 of the leg 1.

The knee joint weight-bearing apparatus 2 includes an outer gas spring 46OUT that generates an outer extension force between the outer thigh link 41OUT and the outer lower-leg link 20OUT in a direction in which the knee joint 3 of the leg 1 extends. The outer gas spring 46OUT is a specific example of the outer extension force generation means. The outer gas spring 46OUT corresponds to the gas spring 46 disposed in the rear thigh link 41 of the thigh connection unit 10 disposed on the outer side of the thigh 4 of the leg 1. As shown in FIGS. 2 and 3, the outer extension force corresponds to the resistive force Q generated by the gas spring 46 disposed in the rear thigh link 41 of the thigh connection unit 10 disposed on the outer side of the thigh 4 of the leg 1.

Further, the inner extension force of the inner gas spring 461N is adjusted so as to become stronger than the outer extension force of the outer gas spring 46OUT. According to the above-described configuration, it is possible, when the leg 1 to which the knee joint weight-bearing apparatus 2 is attached becomes a stance state, to guide the center of gravity of the user to the outer side (i.e., in a direction from the inner thigh link 411N toward the outer thigh link 41OUT), and thereby to reduce the load exerted on the cartilage on the inner side of the knee joint 3 when the leg 1 is an O-shaped bowleg. Therefore, it is possible to alleviate a pain in the knee joint 3 caused by knee osteoarthritis.

The above-described first embodiment can be modified as follows.

That is, the inner extension force of the inner gas spring 461N may be adjusted so as to become weaker than the outer extension force of the outer gas spring 46OUT. According to the above-described configuration, it is possible, when the leg 1 to which the knee joint weight-bearing apparatus 2 is attached becomes a stance state, to guide the center of gravity of the user to the inner side (i.e., in a direction from the outer thigh link 41OUT toward the inner thigh link 411N), and thereby to reduce the load exerted on the cartilage on the outer side of the knee joint 3 when the leg 1 is X-shaped bowleg. Therefore, it is possible to alleviate the pain in the knee joint 3 caused by knee osteoarthritis.

As described above, by making the inner extension force stronger than or weaker than the outer extension force, it is possible, when the leg to which the knee joint weight-bearing apparatus 2 is attached becomes a stance state, to guide the center of gravity of the user to the weaker one of the inner extension force side and the outer extension force side, and thereby to alleviate a pain in the knee joint 3 caused by knee osteoarthritis.

Note that springs or dampers may be used as the inner extension force generation means and the outer extension force generation means. Both a spring and a damper may be used at the same time as the inner extension force generation means and the outer extension force generation means. Specific examples of the spring or the damper include a coil spring, a gas damper, an oil damper, and an oilless gas spring.

Further, when a spring is used as the inner extension force generation means or the outer extension force generation means, the spring may be configured so that its spring constant is adjustable. Similarly, when a damper is used as the inner extension force generation means or the outer extension force generation means, the damper may be configured so that its damping coefficient is adjustable.

### Second Embodiment

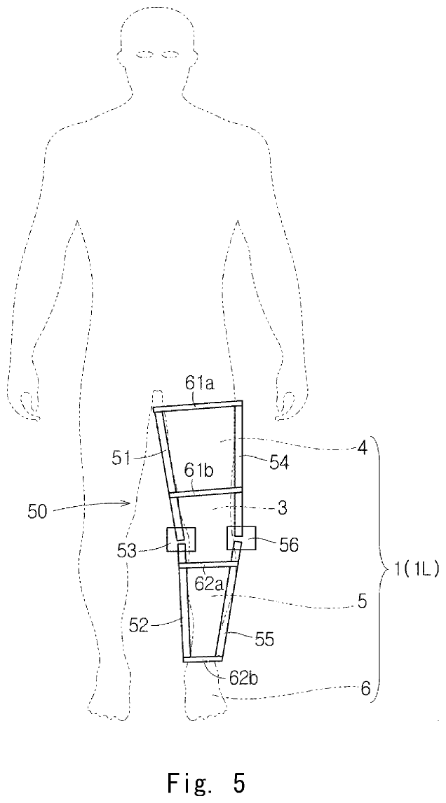

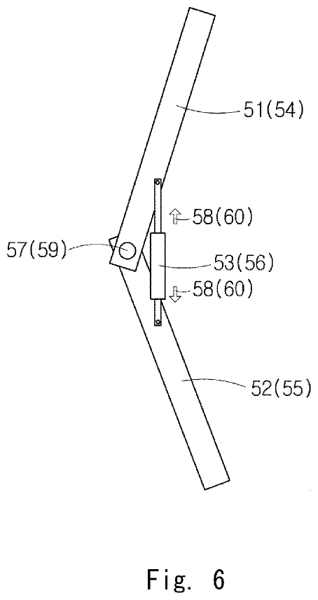

Next, a second embodiment will be described with reference to FIGS. 5 and 6. Note that the same symbols as those used in the above-described first embodiment are used for structures, components, and parts corresponding to those in the above-described first embodiment.

FIG. 5 shows a leg brace 50 which is attached to a leg 1 of a user when it is used. The leg brace 50 is typically used while being attached to one of the two legs 1 of the user in which the user suffers from knee osteoarthritis. However, one leg brace 50 may be attached to each of both legs 1. In this embodiment, the leg brace 50 is attached only to the left leg 1L of the user as shown in FIG. 5.

The leg brace 50 is attached to the leg 1 of the user and, by doing so, reduces a pain in the knee joint 3 of the leg 1.

The leg brace 50 includes an inner thigh link 51, an inner lower-leg link 52, and inner extension force generation means 53.

The leg brace 50 includes an outer thigh link 54, an outer lower-leg link 55, and outer extension force generation means 56.

The inner thigh link 51 is a link that is attached on the inner side of the thigh 4 of the leg 1, and extends along the longitudinal direction of the thigh 4.

The inner lower-leg link 52 is a link that is attached on the inner side of a lower leg 5 of the leg 1, and extends along the longitudinal direction of the lower leg 5.

As shown in FIG. 6, the inner lower-leg link 52 is connected to the inner thigh link 51 so as to be rotatable with respect thereto in the pitch direction. That is, the leg brace 50 includes an inner connection part 57 that rotatably connects the inner thigh link 51 with the inner lower-leg link 52.

The inner extension force generation means 53 generates an inner extension force 58 between the inner thigh link 51 and the inner lower-leg link 52 in a direction in which the knee joint 3 of the leg 1 extends. As the inner extension force generation means 53, it is possible to use, for example, either one of a spring and a damper that is connected to the inner thigh link 51 at one end above the inner connection part 57 and also connected to the inner lower-leg link 52 at the other end below the inner connection part 57. As the inner extension force generation means 53, it is also possible to use one that includes both a spring and a damper so that it exhibits the characteristics of the spring and the damper at the same time.

When a spring is used as the inner extension force generation means 53, the spring may be configured so that its spring constant is adjustable. A typical example of the spring is a compression coil spring.

When a damper is used as the inner extension force generation means 53, the damper may be configured so that its damping coefficient is adjustable.

Referring to FIG. 5 again, the outer thigh link 54 is a link that is attached on the outer side of the thigh 4 of the leg 1, and extends along the longitudinal direction of the thigh 4.

The outer lower-leg link 55 is a link that is attached on the outer side of the lower leg 5 of the leg 1, and extends along the longitudinal direction of the lower leg 5.

As shown in FIG. 6, the outer lower-leg link 55 is connected to the outer thigh link 54 so as to be rotatable with respect thereto in the pitch direction. That is, the leg brace 50 includes an outer connection part 59 that rotatably connects the outer thigh link 54 with the outer lower-leg link 55.

The outer extension force generation means 56 generates an outer extension force 60 between the outer thigh link 54 and the lateral lower-leg link 55 in a direction in which the knee joint 3 of the leg 1 extends. As the outer extension force generation means 56, it is possible to use, for example, either one of a spring or a damper that is connected to the outer thigh link 54 at one end above the outer connection part 59 and also connected to the outer lower-leg link 55 at the other end below the outer connection part 59. As the outer extension force generation means 56, it is also possible to use one that includes both a spring and a damper so that it exhibits the characteristics of the spring and the damper at the same time.

When a spring is used as the outer extension force generation means 56, the spring may be configured so that its spring constant is adjustable. A typical example of the spring is a compression coil spring.

When a damper is used as the outer extension force generation means 56, the damper may be configured so that its damping coefficient is adjustable.

Referring to FIG. 5 again, the inner and outer thigh links 51 and 54 are fixed to the thigh 4 by thigh fixing bands 61a and 61b.

The inner and outer lower-leg links 52 and 55 are fixed to the lower leg 5 by lower-leg fixing bands 62a and 62b.

Further, the inner extension force 58 is adjusted so as to become stronger than or weaker than the outer extension force 60. According to the above-described configuration, it is possible, when the leg 1 to which the leg brace 50 is attached becomes a stance state, to guide the center of gravity of the user to the weaker one of the side of the inner extension force 58 and the side of the outer extension force 60, and thereby to alleviate a pain in the knee joint 3 caused by knee osteoarthritis.

Specifically, in the case where the inner extension force 58 is stronger than the outer extension force 60, it is possible, when the leg 1 to which the leg brace 50 is attached becomes a stance state, to guide the center of gravity of the user toward the outer side, and thereby to alleviate a pain in the knee joint 3 caused by knee osteoarthritis when the leg 1 is an O-shaped bowleg.

Conversely, in the case where the inner extension force 58 is weaker than the outer extension force 60, it is possible, when the leg 1 to which the leg brace 50 is attached becomes a stance state, to guide the center of gravity of the user toward the inner side, and thereby to alleviate a pain in the knee joint 3 caused by knee osteoarthritis when the leg 1 is an X-shaped bowleg.

### Third Embodiment

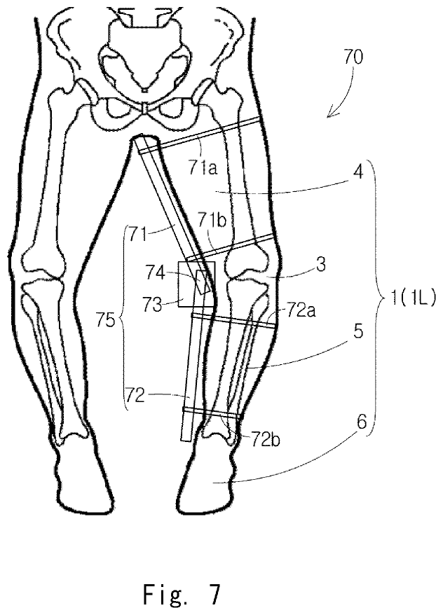

Next, a third embodiment will be described with reference to FIG. 7. Note that the same symbols as those used in the above-described first embodiment are used for structures, components, and parts corresponding to those in the above-described first embodiment. Descriptions that are already given in the above-described first embodiment are omitted.

FIG. 7 shows a leg brace 70 which is attached to a leg 1 of a user when it is used. The leg brace 70 is typically used while being attached to one of the two legs 1 of the user in which the user suffers from knee osteoarthritis. However, one leg brace 70 may be attached to each of both legs 1. In this embodiment, the leg brace 70 is attached only to the left leg 1L of the user as shown in FIG. 7.

The leg brace 70 is attached to the leg 1 of the user and, by doing so, reduces a pain in the knee joint 3 of the leg 1.

The leg brace 70 includes a thigh link 71, a lower-leg link 72, and extension force generation means 73.

The thigh link 71 is a link that is attached to the thigh 4 of the leg 1, and extends along the longitudinal direction of the thigh 4.

The lower-leg link 72 is a link that is attached to a lower leg 5 of the leg 1, and extends along the longitudinal direction of the lower leg 5.

The lower-leg link 72 is connected to the thigh link 71 so as to be rotatable with respect thereto in the pitch direction. That is, the leg brace 70 includes a connection part 74 that rotatably connects the thigh link 71 with the lower-leg link 72.

The thigh link 71 and the lower-leg link 72 form a link unit 75. The link unit 75 is composed of the thigh link 71 and the lower-leg link 72 which is rotatable with respect to the thigh link 71.

The thigh link 71 is fixed to the thigh 4 by thigh fixing bands 71a and 71b.

The lower-leg link 72 is fixed to the lower leg 5 by lower-leg fixing bands 72a and 72b.

The extension force generation means 73 generates an extension force between the thigh link 71 and the lower-leg link 72 in a direction in which the knee joint 3 of the leg 1 extends. As the extension force generation means 73, it is possible to use, for example, either one of a spring or a damper that is connected to the thigh link 71 at one end above the connection part 74 and also connected to the lower-leg link 72 at the other end below the connection part 74. As the extension force generation means 73, it is also possible to use one that includes both a spring and a damper so that it exhibits the characteristics of the spring and the damper at the same time.

When a spring is used as the extension force generation means 73, the spring may be configured so that its spring constant is adjustable. A typical example of the spring is a compression coil spring.

When a damper is used as the extension force generation means 73, the damper may be configured so that its damping coefficient is adjustable.

Further, as shown in FIG. 7, the link unit 75 is disposed only on one of the inner side and the outer side of the leg 1. According to the above-described configuration, it is possible, when the leg 1 to which the leg brace 70 is attached becomes a stance state, to guide the center of gravity of the user toward the side opposite to the side on which the link unit 75 is disposed, and thereby to alleviate a pain in the knee joint 3 caused by knee osteoarthritis.

Specifically, the link unit 75 is disposed on the inner side of the leg 1. According to the above-described configuration, it is possible, when the leg 1 to which the leg brace 70 is attached becomes a stance state, to guide the center of gravity of the user toward the outer side, and thereby to alleviate a pain in the knee joint 3 caused by knee osteoarthritis when the leg 1 is an O-shaped bowleg.

### Fourth Embodiment

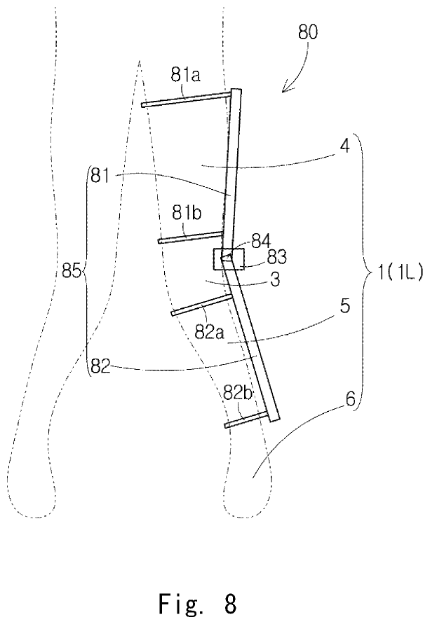

Next, a fourth embodiment will be described with reference to FIG. 8. Note that the same symbols as those used in the above-described first embodiment are used for structures, components, and parts corresponding to those in the above-described first embodiment. Descriptions that are already given in the above-described first embodiment are omitted.

FIG. 8 shows a leg brace 80 which is attached to a leg 1 of a user when it is used. The leg brace 80 is typically used while being attached to one of the two legs 1 of the user in which the user suffers from knee osteoarthritis. However, one leg brace 80 may be attached to each of both legs 1. In this embodiment, the leg brace 80 is attached only to the left leg 1L of the user as shown in FIG. 8.

The leg brace 80 is attached to the leg 1 of the user and, by doing so, reduces a pain in the knee joint 3 of the leg 1.

The leg brace 80 includes a thigh link 81, a lower-leg link 82, and extension force generation means 83.

The thigh link 81 is a link that is attached to the thigh 4 of the leg 1, and extends along the longitudinal direction of the thigh 4.

The lower-leg link 82 is a link that is attached to a lower leg 5 of the leg 1, and extends along the longitudinal direction of the lower leg 5.

The lower-leg link 82 is connected to the thigh link 81 so as to be rotatable with respect thereto in the pitch direction. That is, the leg brace 80 includes a connection part 84 that rotatably connects the thigh link 81 with the lower-leg link 82.

The thigh link 81 and the lower-leg link 82 form a link unit 85. The link unit 85 is composed of the thigh link 81 and the lower-leg link 82 which is rotatable with respect to the thigh link 81.

The thigh link 81 is fixed to the thigh 4 by thigh fixing bands 81a and 81b.

The lower-leg link 82 is fixed to the lower leg 5 by lower-leg fixing bands 82a and 82b.

The extension force generation means 83 generates an extension force between the thigh link 81 and the lower-leg link 82 in a direction in which the knee joint 3 of the leg 1 extends. As the extension force generation means 83, it is possible to use, for example, either one of a spring or a damper that is connected to the thigh link 81 at one end above the connection part 84 and also connected to the lower-leg link 82 at the other end below the connection part 84. As the extension force generation means 83, it is also possible to use one that includes both a spring and a damper so that it exhibits the characteristics of the spring and the damper at the same time.

When a spring is used as the extension force generation means 83, the spring may be configured so that its spring constant is adjustable. A typical example of the spring is a compression coil spring.

When a damper is used as the extension force generation means 83, the damper may be configured so that its damping coefficient is adjustable.

Further, as shown in FIG. 8, the link unit 85 is disposed only on one of the inner side and the outer side of the leg 1. According to the above-described configuration, it is possible, when the leg 1 to which the leg brace 80 is attached becomes a stance state, to guide the center of gravity of the user toward the side opposite to the side on which the link unit 85 is disposed, and thereby to alleviate a pain in the knee joint 3 caused by knee osteoarthritis.

Specifically, the link unit 85 is disposed on the outer side of the leg 1. According to the above-described configuration, it is possible, when the leg 1 to which the leg brace 80 is attached becomes a stance state, to guide the center of gravity of the user toward the inner side, and thereby to alleviate a pain in the knee joint 3 caused by knee osteoarthritis when the leg 1 is an X-shaped bowleg.

### Fifth Embodiment

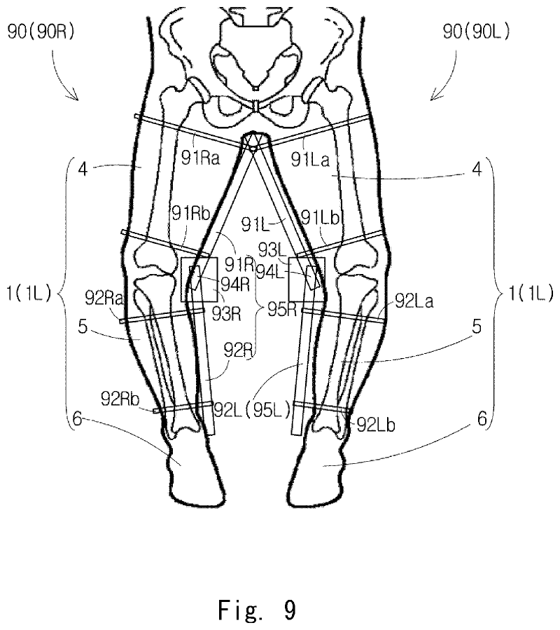

Next, a fifth embodiment will be described with reference to FIG. 9. Note that the same symbols as those used in the above-described first embodiment are used for structures, components, and parts corresponding to those in the above-described first embodiment. Descriptions that are already given in the above-described first embodiment are omitted.

FIG. 9 shows a leg brace unit 90 which is attached to a pair of legs 1 of a user when it is used. The leg brace unit 90 includes a leg brace 90L for a left leg 1L and a leg brace 90R for a right leg 1R.

The leg brace unit 90 is attached to both legs 1L and 1R of the user and, by doing so, reduces a pain(s) in the knee joint(s) 3 of the leg(s) 1.

The leg brace 90L includes a thigh link 91L, a lower-leg link 92L, and extension force generation means 93L.

The thigh link 91L is a link that is attached to the thigh 4 of the left leg 1L, and extends along the longitudinal direction of the thigh 4.

The lower-leg link 92L is a link that is attached to the lower leg 5 of the left leg 1L, and extends along the longitudinal direction of the lower leg 5.

The lower-leg link 92L is connected to the thigh link 91L so as to be rotatable with respect thereto in the pitch direction. That is, the leg brace 90L includes a connection part 94L that rotatably connects the thigh link 91L with the lower-leg link 92L.

The thigh link 91L and the lower-leg link 92L form a link unit 95L. The link unit 95L is composed of the thigh link 91L and the lower-leg link 91L which is rotatable with respect to the thigh link 92L.

The thigh link 91L is fixed to the thigh 4 by thigh fixing bands 91La and 91Lb.

The lower-leg link 92L is fixed to the lower leg 5 by lower-leg fixing bands 92La and 92Lb.

The extension force generation means 93L generates an extension force between the thigh link 91L and the lower-leg link 92L in a direction in which the knee joint 3 of the left leg 1L extends. As the extension force generation means 93L, it is possible to use, for example, either one of a spring or a damper that is connected to the thigh link 91L at one end above the connection part 94L and also connected to the lower-leg link 92L at the other end below the connection part 94L. As the extension force generation means 93L, it is also possible to use one that includes both a spring and a damper so that it exhibits the characteristics of the spring and the damper at the same time.

When a spring is used as the extension force generation means 93L, the spring may be configured so that its spring constant is adjustable. A typical example of the spring is a compression coil spring.

When a damper is used as the extension force generation means 93L, the damper may be configured so that its damping coefficient is adjustable.

Further, as shown in FIG. 9, the link unit 95L is disposed only on one of the inner side and the outer side of the left leg 1L. In this embodiment, the link unit 95L is disposed on the inner side of the left leg 1L. Alternatively, the link unit 95L may be disposed on the outer side of the left leg 1L.

Similarly, the leg brace 90R includes a thigh link 91R, a lower-leg link 92R, and extension force generation means 93R.

The thigh link 91R is a link that is attached to the thigh 4 of the right leg 1R, and extends along the longitudinal direction of the thigh 4.

The lower-leg link 92R is a link that is attached to the lower leg 5 of the left leg 1L, and extends along the longitudinal direction of the lower leg 5.

The lower-leg link 92R is connected to the thigh link 91R so as to be rotatable with respect thereto in the pitch direction. That is, the leg brace 90R includes a connection part 94R that rotatably connects the thigh link 91R with the lower-leg link 92R.

The thigh link 91R and the lower-leg link 92R form a link unit 95R. The link unit 95R is composed of the thigh link 91R and the lower-leg link 91R which is rotatable with respect to the thigh link 92R.

The thigh link 91R is fixed to the thigh 4 by thigh fixing bands 91Ra and 91Rb.

The lower-leg link 92R is fixed to the lower leg 5 by lower-leg fixing bands 92Ra and 92Rb.

The extension force generation means 93R generates an extension force between the thigh link 91R and the lower-leg link 92R in a direction in which the knee joint 3 of the right leg 1R extends. As the extension force generation means 93R, it is possible to use, for example, either one of a spring or a damper that is connected to the thigh link 91R at one end above the connection part 94R and also connected to the lower-leg link 92R at the other end below the connection part 94R. As the extension force generation means 93R, it is also possible to use one that includes both a spring and a damper so that it exhibits the characteristics of the spring and the damper at the same time.

When a spring is used as the extension force generation means 93R, the spring may be configured so that its spring constant is adjustable. A typical example of the spring is a compression coil spring.

When a damper is used as the extension force generation means 93R, the damper may be configured so that its damping coefficient is adjustable.

Further, as shown in FIG. 9, the link unit 95R is disposed only on one of the inner side and the outer side of the right leg 1R. In this embodiment, the link unit 95R is disposed on the inner side of the right leg 1R. Alternatively, the link unit 95R may be disposed on the outer side of the right leg 1R.

Further, the extension force of the extension force generation means 93L of the leg brace 90L is stronger than or weaker than that of the extension force generation means 93R of the leg brace 90R. According to the above-described configuration, it is possible, when a user walks, to actively guide the center of gravity of the user toward the side on which the extension force is weaker, and thereby to alleviate a pain in the knee joint 3 caused by knee osteoarthritis.

Specifically, in the case where the extension force of the extension force generation means 93L of the leg brace 90L is stronger than that of the extension force generation means 93R of the leg brace 90R, the center of gravity of the user is actively guided to the side of the right leg 1R when the user walks. Therefore, when the right leg 1R is an O-shaped bowleg, a pain in the knee joint 3 of the right leg 1R can be alleviated. Further, when the left leg 1L is an X-shaped bowleg, a pain in the knee joint 3 of the left leg 1L can be alleviated.

Conversely, in the case where the extension force of the extension force generation means 93L of the leg brace 90L is weaker than that of the extension force generation means 93R of the leg brace 90R, the center of gravity of the user is actively guided to the side of the left leg 1L when the user walks. Therefore, when the right leg 1R is an X-shaped bowleg, a pain in the knee joint 3 of the right leg 1R can be alleviated. Further, when the left leg 1L is an O-shaped bowleg, a pain in the knee joint 3 of the left leg 1L can be alleviated.

### Sixth Embodiment

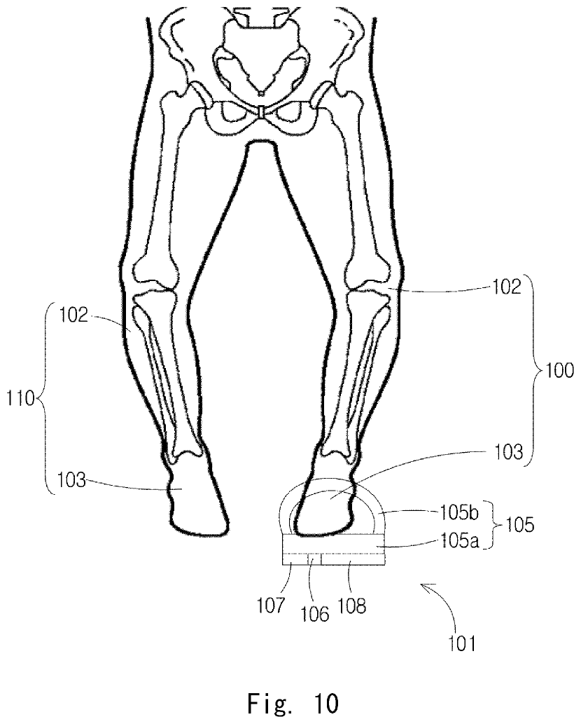

A sixth embodiment will be described hereinafter with reference to FIG. 10. Note that the same symbols as those used in the above-described first embodiment are used for structures, components, and parts corresponding to those in the above-described first embodiment. Descriptions that are already given in the above-described first embodiment are omitted.

FIG. 10 shows a lower-limb brace 101 attached to a lower limb 100 of a user. The lower limb 100 includes a leg 102 and a foot 103. In this embodiment, the lower-limb brace 101 is attached to the foot 103. Alternatively, the lower-limb brace 101 may be attached to the leg 102, or to the leg 102 and the foot 103 in such a manner that the lower-limb brace 101 straddles the leg 102 and the foot 103.

The lower-limb brace 101 includes a brace main body 105, a load removal detection unit 106, force-applying means 107, and a control unit 108.

The brace main body 105 includes a sole part 105a disposed on the sole of the foot 103 of the user, and an instep part 105b disposed on the instep side of the foot 103. The brace main body 105 is attached to the foot 103 of the user by sandwiching the foot 103 between the sole part 105a and the instep part 105b. However, the shape of the brace main body 105 is not limited to the above-described example.

The load removal detection unit 106 detects that a load exerted on the lower limb 100 is removed. The load removal detection unit 106 is typically a pressure sensor, and is disposed in the sole part 105a. Alternatively, the load removal detection unit 106 may adopt other configurations by which it can detect that a load exerted on the lower limb 100 is removed. For example, the load removal detection unit 106 may use a contact sensor or the like. It can be considered that the timing at which a load on the lower limb 100 is removed is substantially simultaneous with the timing at which the state of the lower limb 100 changes from a stance state to a swing state. The load removal detection unit 106 outputs the result of the detection to the control unit 108.

The force-applying means 107 is capable of applying a force to the brace main body 105 in a direction in which the brace main body 105 recedes from the ground surface, and typically includes a solenoid coil and a rod that moves forward and backward according to the energization of the solenoid coil. For example, when the solenoid coil is energized, the rod is driven to move toward the ground surface, so that the force-applying means 107 applies a force to the brace main body 105 in a direction in which the brace main body 105 recedes from the ground surface.

The control unit 108 controls the force-applying means 107 so that when the load on the lower limb 100 is removed, the force-applying means 107 applies a force to the brace main body 105 in the direction in which the brace main body 105 recedes from the ground surface.

The control unit 108 includes a CPU (Central Processing Unit) that serves as a central processing unit, a readable/writable RAM (Random Access Memory), and a read-only ROM (Read Only Memory). Further, when the CPU loads and executes a control program stored in the ROM, the control program causes hardware such as the CPU to function as the control unit 108.

According to the above-described configuration, it is possible, when a user walks, to guide the center of gravity of the user toward the lower limb 110 opposite to the lower limb 100 to which the lower-limb brace 101 is attached at the timing when the state of the lower limb 100 changes from a stance state to a swing state. Therefore, it is possible to alleviate a pain in the knee joint 3 caused by knee osteoarthritis of the lower limb 110 when the lower limb 110 opposite to the lower limb 100 to which the lower-limb brace 101 is attached is an O-shaped bowleg.

The stance state of the leg is a state where the corresponding foot is in contact with the floor, while the swing state of the leg is a state where the corresponding foot is not in contact with the floor.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A leg brace configured to be attached to a leg of a user, comprising:
an inner thigh link configured to be attached to an inner side of a thigh of the leg;
an inner lower-leg link rotatably connected to the inner thigh link, and configured to be attached to an inner side of a lower leg of the leg;
an inner extension force generator generating an inner extension force between the inner thigh link and the inner lower-leg link in a direction in which a knee joint of the leg extends;
an outer thigh link configured to be attached to an outer side of the thigh of the leg;
an outer lower-leg link rotatably connected to the outer thigh link, and configured to be attached to an outer side of the lower leg of the leg; and
an outer extension force generator generating an outer extension force between the outer thigh link and the outer lower-leg link in a direction in which the knee joint of the leg extends, wherein
the inner extension force is stronger than or weaker than the outer extension force.

2. The leg brace according to claim 1, wherein the inner extension force is stronger than the outer extension force.

3. The leg brace according to claim 1, wherein the inner extension force is weaker than the outer extension force.

4. The leg brace according to claim 1, wherein the inner extension force generator and the outer extension force generator comprise a spring or a damper.

5. The leg brace according to claim 1, wherein the inner extension force generator and the outer extension force generator comprise a spring configured so that its spring constant is adjustable.

6. The leg brace according to claim 1, wherein the inner extension force generator and the outer extension force generator comprise a damper configured so that its damping coefficient is adjustable.

7. A leg brace configured to be attached to a leg of a user, comprising:
a thigh link configured to be attached to a thigh of the leg;
a lower-leg link rotatably connected to the thigh link, and configured to be attached to a lower leg of the leg; and
an extension force generator generating an extension force between the thigh link and the lower-leg link in a direction in which a knee joint of the leg extends, wherein
the thigh link and the lower-leg link form a link unit, and
the link unit is disposed only on one of an inner side and an outer side of the leg.

8. The leg brace according to claim 7, wherein the link unit is disposed on an inner side of the leg.

9. The leg brace according to claim 7, wherein the link unit is disposed on an outer side of the leg.

10. A leg brace unit comprising a pair of leg braces each of which is attached to a respective one of legs of a user, wherein
each of the leg braces comprises:
a thigh link configured to be attached to a thigh of a corresponding leg;
a lower-leg link rotatably connected to the thigh link, and configured to be attached to a lower leg of the corresponding leg; and
an extension force generator generating an extension force between the thigh link and the lower-leg link in a direction in which a knee joint of the leg extends, and
an extension force of one of the leg braces is stronger than or weaker than that of the other leg brace.

11. A lower-limb system comprising:
a brace main body configured to be attached to a lower limb of a user;
a load removal detection unit configured to detect that a load exerted on the lower limb is removed;
a force-applying unit capable of applying a force to the brace main body in a direction in which the brace main body recedes from a ground surface; and
a control unit configured to control the force-applying unit so that when the load exerted on the lower limb is removed, the force-applying unit applies the force to the brace main body in the direction in which the brace main body recedes from the ground surface.
